(19) United States
(12) Patent Application Publication
(10) Pub. No.: US 2008/0127190 A1
(43) Pub. Date: May 29, 2008

(54) METHOD AND SYSTEM FOR PROCESSING A SCHEDULING TASK IN DEVICE MANAGEMENT

(76) Inventors: Qi Shu, Shenzhen (CN); Linyi Tian, Shenzhen (CN)

Correspondence Address: LADAS & PARRY LLP, 224 SOUTH MICHIGAN AVENUE, SUITE 1600, CHICAGO, IL, 60604, US

(21) Appl. No.: 11/959,723

(22) Filed: Dec. 19, 2007

Related U.S. Application Data
(63) Continuation of application No. PCT/CN2006/002967, filed on Nov. 6, 2006.

(30) Foreign Application Priority Data
Nov. 10, 2005 (CN) 200510115109.0

(51) Int. Cl. G06F 9/46

(52) U.S. Cl. 718/102

(57) ABSTRACT

A method, device, device management server and system for processing a scheduling task in device management are provided. The method includes: a device management server delivering a scheduling task; a device monitoring an execution condition of the scheduling task; the device reporting information on execution of the task; if the device does not execute the task normally according to the execution condition, the device management server delivering a task, and the device executing an operation according to the instruction; and the device reporting a task execution status. Thus, an effective mechanism for ensuring execution of the scheduling task is provided, so that the uncertainty in device management may be reduced, the flexibility of device management on the mobile phone may be increased, a scheduling demand from the user may be satisfied, and the quality of device management services may be improved.

This application is a Continuation Application of PCT/CN2006/002967 submitted on Nov. 6, 2006, claiming the priority from Chinese Patent application No. 200510115109.0 submitted on Nov. 10, 2005, the contents of which are incorporated herein by reference.

### FIELD OF THE INVENTION

The present invention relates to the field of communications, and in particular to a method, device and system for processing a scheduling task in device management.

### BACKGROUND OF THE INVENTION

Currently, a task scheduling mechanism has been provided in the industry. A Device Management Server (DMS) may schedule a certain task and execution condition based upon this mechanism, and the scheduling task and execution condition may be downloaded to a terminal. When the status of the terminal satisfies the scheduling task and execution condition, an operation corresponding to the task may be performed. In this way, the task scheduling mechanism provides such a mechanism that enables a terminal to perform a management operation delivered from the server at a given time or in a given condition even when the terminal is in an offline state.

The task scheduling mechanism may reduce the cost of network operations during device management, improve the flexibility of device management and enhance the experience of a high-end user, so that the user may make a timely response to a certain local event without the interaction with the DMS. For example, the user may postpone the execution of a scheduling task on account of his inconvenience.

FIG. 1 shows a Device Management in existing task scheduling mechanism, i.e. a processing flow of the management operation mode of a scheduling task, including:

Step 1, a device management server initiates an operation notification to a terminal.

Step 2, the terminal establishes a session connection of which the interactive authorization is omitted.

Step 3, the device management server delivers a management operation task.

Step 4, the terminal prompts a user with the information of the delivered management operation task.

Step 5, the user accepts the management scheduled operation task.

Step 6, the terminal reports the status of the task.

Step 7, the device management server finishes the current interaction of sending the management operations to the device and may further send management operations for next interaction.

Step 8, the terminal monitors the execution condition of the management operation task.

Step 9, the terminal executes the management operation task.

Step 10, the terminal establishes a connection and reports the execution status of the task.

Step 11, the device management server finishes the current interaction of sending the management operations to the device and may further send management operations for next interaction.

Through the above procedure, the existing device management specification may implement the management operation mode of scheduling task.

However, a terminal device may be brought into an abnormal state. For example, a terminal may be switched off due to insufficient power, at a user-set time, upon an abnormal event, or due to the intervention of the user, etc. It is apparent that the existing management operation mode of scheduling task can not deal with these abnormalities which are very likely to occur. Thus when such an abnormality occurs, the scheduling task in the terminal can not be executed normally. In other words, the existing device management specification lacks the support for the events of abnormality, resulting in an imperfect specification of the management operation mode of scheduling task. In the existing management operation mode of scheduling task, it can be seen that:

1. There is a lack of a mechanism that may ensure the execution of a scheduling task management operation.

2. The DMS is incapable of tracking the execution of a scheduling task management operation normally.

3. The uncertainty in the terminal device management is increased.

4. The flexibility of the terminal device management is reduced.

5. The scheduling command from the user can not be satisfied.

6. The quality of the terminal device management is reduced.

### SUMMARY OF THE INVENTION

The embodiments of the invention provide a method, terminal, device management server and system for processing a scheduling task in device management, the device management server may track a delivered scheduling task, and notify the terminal to which the scheduling task has been delivered, or trigger the execution of the scheduling task.

An embodiment of the invention provides a method for processing a scheduling task in device management. The method includes:

receiving a scheduling task delivered by a device management server, and tracking the scheduling task according to an execution condition and a task tracking policy of the scheduling task; and reporting a tracking information to the device management server according to the task tracking policy.

Optionally, the method may further include: delivering, by the device management server, a task instruction to a device if it is determined according to the reported tracking information that the device does not execute the task according to an execution condition, and executing the task by the device according to the task instruction.

Optionally, the task tracking policy may include at least one of:

the device noting the device management server when reaching or exceeding a time limit for executing a scheduling task; or

the device notifying the device management server if an execution condition of a scheduling task is modified by a user; or

the device notifying the device management server if an execution condition of a task is missed and the device does not execute normally; or

reporting information of a task to the device management server automatically upon a predetermined event or at a predetermined time.

Optionally, reporting the tracking information to the device management server may include:

sending, by the device to a short message gateway by using a short message, the tracking information obtained according to the execution condition and the task tracking policy of the task, and sending, by the short message gateway, the tracking information to the device management server; or,

reporting, by the device, to the device management server through a session connection which is established between the device and the device management server, the tracking information obtained according to the execution condition and the task tracking policy of the task.

Another embodiment of the invention provides a device with an interface for communication with a device management server, for receiving a scheduling task delivered from the device management server, the device may include:

a task execution unit, capable of executing a scheduling task delivered from the device management server, and providing a task status reporting unit with a task execution result;

a task abnormality processing unit, capable of processing an abnormal task, and reporting a task abnormality status according to a predetermined task tracking policy; and

a task status reporting unit, capable of reporting to the device management server the task execution result and the task abnormality status.

Optionally, the task execution unit may be further capable of receiving an compulsive-execution instruction for a scheduling task or an operation selection instruction, and performing a compulsive execution or display information prompting to select an operation with respect to the scheduling task according to the instruction.

Still another embodiment of the invention provides a device management server for delivering a scheduling task to a device and performing management on the device, which may include:

a task status report processing unit, capable of receiving a task execution result and task abnormality status information reported from the device with respect to the scheduling task.

Optionally, the device management server may further include:

a task contents management unit, capable of delivering a task instruction to the device after it is determined according to the reported task execution result and task abnormality status information that the device does not execute the scheduling task according to an execution condition, wherein the device operates according to the task instruction, and the task instruction may be a compulsive-execution instruction or an operation selection instruction.

A further embodiment of the invention provides a system for processing a scheduling task in device management, adapted to manage a scheduling task delivered from a device management server to a device, which may include:

a device management server, capable of delivering a scheduling task to a device, and obtaining tracking information from the device; and

a device, capable of receiving the scheduling task, tracking the scheduling task according to an execution condition and a task tracking policy of the scheduling task, and reporting the tracking information to the device management server.

With the technical solutions according to the embodiments of the present invention mention above, the problem in the management operation mode of scheduling task in the prior art may be solved. That is, a scheduling task may be executed normally even in the case that the device is switched off automatically due to insufficient power, at a user-set time, upon an abnormal event, or due to user intervention, etc. In other words, the embodiments of the invention provide an effective mechanism for ensuring the execution of a scheduling task, the uncertainty in device management may be reduced, the flexibility of device management may be increased, the scheduling demand from the user may be satisfied, and the quality of the device management services may be improved.

### BRIEF DESCRIPTIONS OF THE DRAWINGS

FIG. 1 is a flow chart showing the management operation mode of scheduling task in the prior art;

FIG. 2 is a schematic diagram showing the relationships between functional component modules in the OMA DM specification;

FIG. 3 is a schematic diagram showing a management tree;

FIG. 4 is a schematic diagram showing a network topology of device management;

FIG. 5 is a schematic diagram showing an implementation procedure for reporting task information through a short message according to an embodiment of the invention;

FIG. 6 is a schematic diagram showing an implementation procedure for reporting information through a device management session connection according to an embodiment of the invention;

FIG. 7 is a schematic diagram showing an implementation procedure for establishing a session connection and reporting about task execution as illustrated in FIG. 6;

FIG. 8 is a schematic diagram showing an implementation procedure for tracking and notifying by a device management server according to an embodiment of the invention;

FIG. 9 is a schematic diagram showing an implementation procedure for processing a task which is not executed normally and the final time limit for execution has not been exceeded according to an embodiment of the invention; and

FIG. 10 is a schematic diagram showing the structure of a system according to an embodiment of the invention.

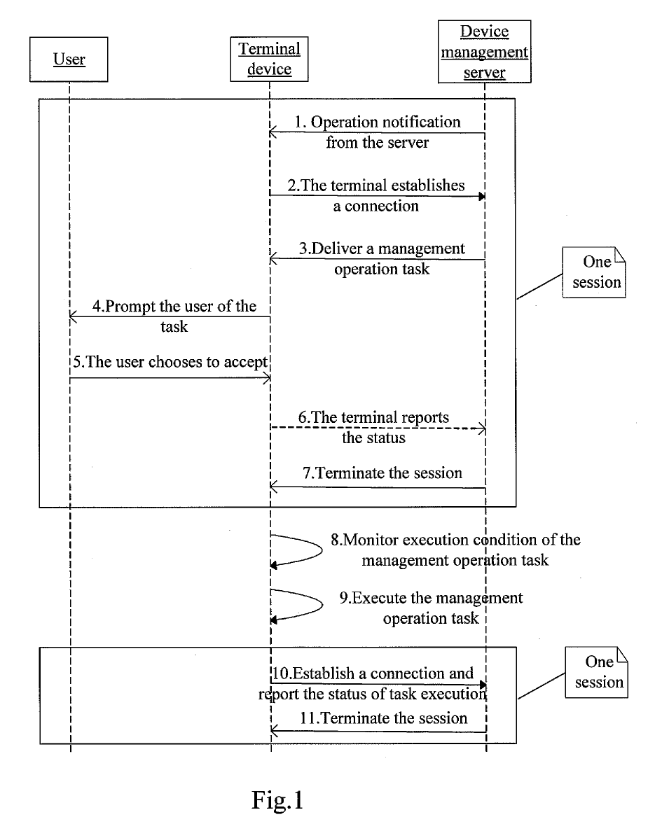

### DETAILED DESCRIPTIONS OF THE EMBODIMENTS

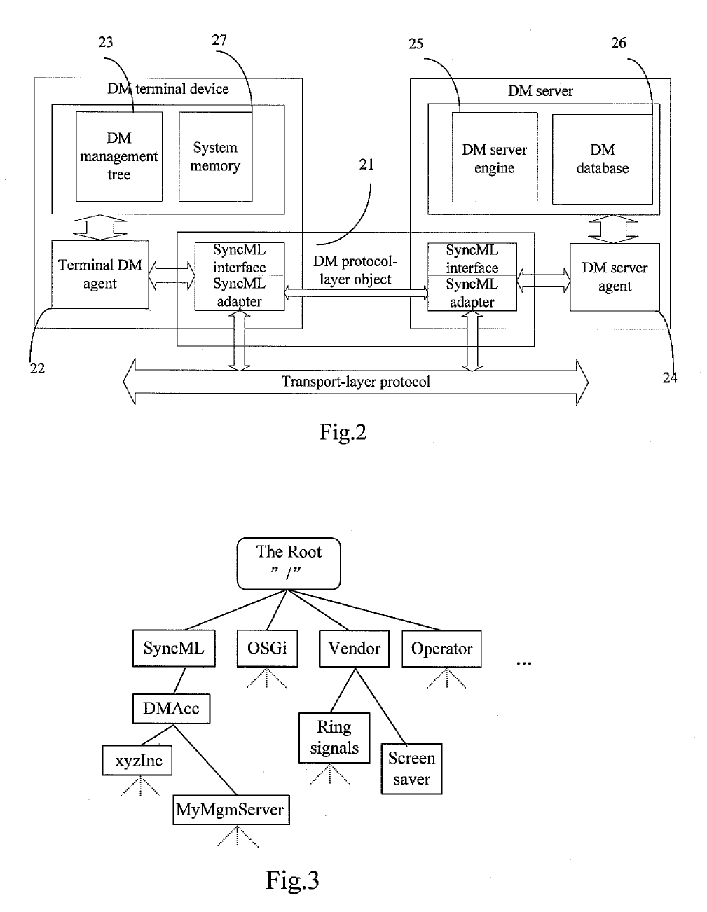

The embodiments of the invention will be further detailed hereinafter with reference to FIG. 2 to FIG. 10.

FIG. 2 shows the relationships between the functional component modules of a device management server and a terminal in a device management system. The functional component modules will be described as follows:

A translation and interface module 21 is configured in the device management and the device management server (DMS), and is a necessary function component for the interaction of the protocol-layer information. There is an interface between this module 21 and a terminal device management agent 22.

A terminal device management agent 22 is adapted to parse the contents of protocols, translate a management operation instruction delivered from the device management server into a terminal executable operation instruction, and notify the terminal to execute the operation.

Another important functional component necessary for the parsing of protocols is a device management tree 23.

The device management tree 23 may be regarded as an interface through which the device management server manages the terminal device using device management protocol. The device management tree includes some basic management objects. The device management server may control the resources of the terminal device by performing some operations upon the objects on the management tree.

The device management tree 23 is as illustrated in FIG. 3. In the device management tree 23, all of the management objects available in the device are organized into a tree-like structure, each of the nodes is identified with a unique Uniform Resource Identifier (URI), and a relevant operation may be delivered targeting the nodes on the device management tree. The structure of the message of the protocol is implemented based on the eXtensible Makeup Language (XML). A node of the management tree may include a set of environment configuration parameters in the system memory of the terminal, different types of objects, relevant operations, triggering mechanisms of some applications etc.

A system memory 27 is mainly adapted to store data.

A device management server agent 24 is a functional component for delivering a device management operation to a terminal of device management and for processing the specific operations of device management.

A device management server engine 25 is a functional component for device management, which performs a background management of device management operation.

A device management database 26 is adapted to maintain the terminal capability information, terminal operation information, terminal task information and device management-related data information. Furthermore, an external interface module is provided for management and connection of the external systems (for example, other service sub-system of an operator, a third-party terminal manufacturer, etc.).

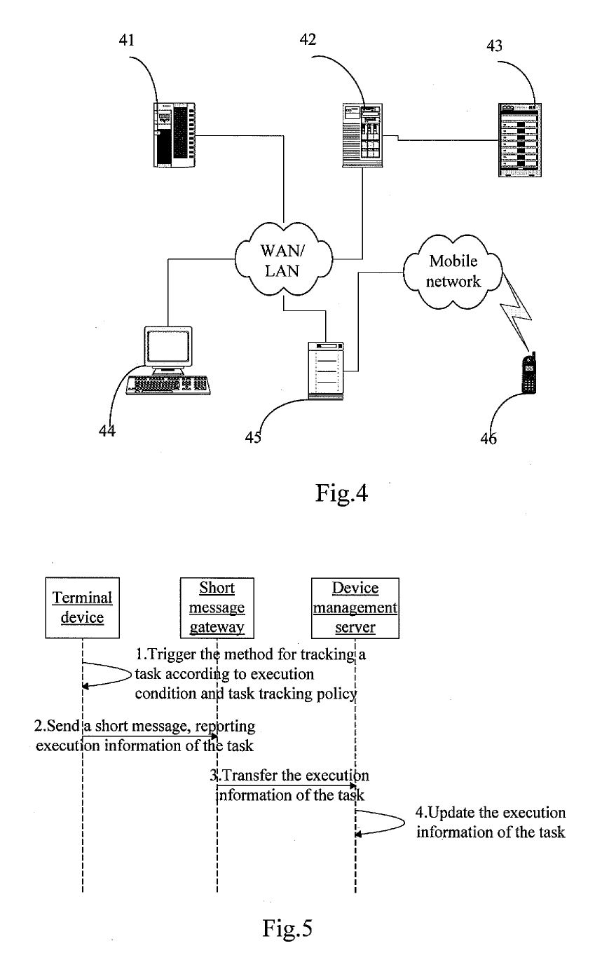

FIG. 4 is a schematic diagram showing a network topology of device management, wherein a terminal manufacturer/third-party server 41, a PC terminal device 44 and a device management server (DMS) 42 are connected through a wide area network (WAN) or a local area network (LAN), a mobile terminal device 46 is interconnected with these devices by use of a gateway 45 through a mobile network. The data in the device management server 42 is stored in a data storage server 43. As can be seen from FIG. 4, the device management terminal 46 may be a mobile terminal, such as a mobile phone, a palm computer, a notebook computer, an embedded device, a vehicle mounted system or the like, or the device management terminal 46 may be a fixed terminal, such as a Personal Computer (PC) or the like. Of course, any other terminal device which may be used shall not be excluded, and the bearer network shall not be limited to any specific type.

A method for processing a scheduling task in device management according to an embodiment of the invention will be described below by way of an example of an implementation procedure for scheduling a task through a mobile phone, in conjunction with the above described functional components.

A. A device management server delivers a scheduling task.

In particular, the device management server first sends a notification to a mobile phone, and the mobile phone establishes a session connection and performs an interactive authorization. Then, the server delivers a management operation task, that is, delivers the scheduling task information.

Alternatively, the device management server may deliver the scheduling task information by other ways.

This step may further involve a process that the mobile phone reports to the device management server about its status.

B. The mobile phone monitors the execution condition of executing the scheduling task (i.e. the management scheduling task) delivered from the device management server, and executes the scheduling task delivered from the device management server if an execution condition is satisfied when tracking the device status.

That is, after the device management server delivers the scheduling task, the mobile phone executes a corresponding operation according to the execution condition of the scheduling task, and tracks according to the execution condition.

The reason for tracking the scheduling task will be described hereinafter.

In general, the execution condition of a management operation task is mostly a time condition, and may also involve responding to an event and monitoring the value of a certain status parameter of the mobile phone. Of course, a combination condition including different types of conditions shall not be excluded.

For example, the device management server delivers a scheduling task which is required to be executed by the mobile phone at the time 10:00 PM 20050803 or at the time when an event of switching on the mobile phone occurs. Alternatively, the network signal of the mobile phone may be monitored, and the information about network performance parameters may be recorded when that signal is below a certain threshold.

Since the execution conditions for the scheduling task may vary, and some execution conditions may be allowed to be modified by a user, the complexity of the management operation task may increase greatly. In this regard, it would be difficult for the mobile phone to ensure the normal execution of a scheduling task according to the execution condition thereof, if the device management server provides no good tracking mechanism.

For this reason, a corresponding task tracking mechanism is provided according to an embodiment of the invention. Several policies that may be adopted for task tracking will be described as follows, though the invention shall not be limited thereto:

1. If a time limit for executing a scheduling task is due or exceeded, the mobile phone notifies the device management server.

2. If the user modifies the execution condition of a scheduling task, the mobile phone notifies the device management server.

3. If the task execution condition is missed and the mobile phone does not execute the scheduling task normally, the mobile phone notifies the device management server.

4. Task information may be reported automatically to the device management server upon a certain event or at a certain time (for example, when switching on the mobile phone).

The above four polices exemplify a method of terminal notification mechanism. An Alert type of message defined in the OMA DM protocol may be used uniformly to notify the server. This Alert type of message may also be referred to as a Generic Alert message. The Generic Alert message may be sent by a client to the server. Upon receiving the Generic Alert message, the server must return Status information about the processing of the respective Items therein.

The following example shows the basic structure of a Generic Alert message which is described with XML.

<Alert>

<CmdID>2</CmdID>
<Data>1226</Data> <!-- Generic Alert --> //Indicative of Generic Alert message
<Correlator>abc123</Correlator>
<Item>

<Source><LocURI>./SyncML/Sample</LocURI></Source>
<Meta>

<Type xmlns=“syncml:metinf”>

org.openmobilealliance.dm.scheduling.report //Description of the type of message

contents

</Type>
<Format xmlns=“syncml:metinf”>xml</Format> //Message format
<Mark xmlns=“syncml:metinf”>critical</Mark> //Optional; description of importance level

of message

| </Meta> | |
|---|---|
| <Data> | //Specific message contents including descriptions of task |

<![CDATA[

<Sched>

| | |
|---|---|
| <SchId>ACTRPG0798</SchId> | //Task identifier |
| <SimpSch> | |

| | |
|---|---|
| <SSchId>ACTRPG0798S01</SSchId> | //Task condition identifier |

| | |
|---|---|
| <Dur> im..2005-08-03T22:00:00Z </Dur> | //Triggering time |
| <stat>miss</stat> | //Status of Task |

</SimpSch>

</Sched>

]]>

</Data>

</Item>

</Alert>

The device management server may constitute a task tracking policy based upon the characteristics of the scheduling task, and deliver the policy to the mobile phone. In addition 110 to monitoring the execution condition of the scheduling task, the mobile phone has to notify the device management server about the relevant information of the tracking according to the task tacking policy constituted by the device management server, the device management server may track the execution of a scheduling task normally.

C. The mobile phone reports the execution of a task (i.e. tracking information).

There may be two types of method for the mobile phone to report the execution of a task, that is, the method for the mobile phone to report the task information, which are as follows:

1. a method for reporting the task information by means of short message

FIG. 5 illustrates a corresponding processing procedure which is as follows:

Step C1, the terminal triggers the method for tracking a task according to the execution condition of a scheduling task (i.e. the condition for triggering the execution) and the task tracking policy, to track the scheduling task of the terminal.

Step C2, the mobile phone sends a short message to a short message gateway reporting the execution information of the task.

The step C2 may include the following steps.

Step C21, a Device Management Agent (DM Agent) on the terminal automatically sends to the short message gateway a designated instruction including the execution information of the task.

Step C22, the short message gateway forwards the message to the device management server according to the instruction, and thus the device management server may obtain the execution information of the task on the terminal.

Step C3, the short message gateway transfers the execution information of the task to the device management server.

Step C4, the device management server updates the execution information of the task.

The format of the short message packet may be complied with the international standards, which is known in the prior art and thus will not be detailed here. Of course, other message formats for transmitting the execution information of the task may be used in other embodiments of the invention.

2. A method for reporting the task information by establishing a device management session connection

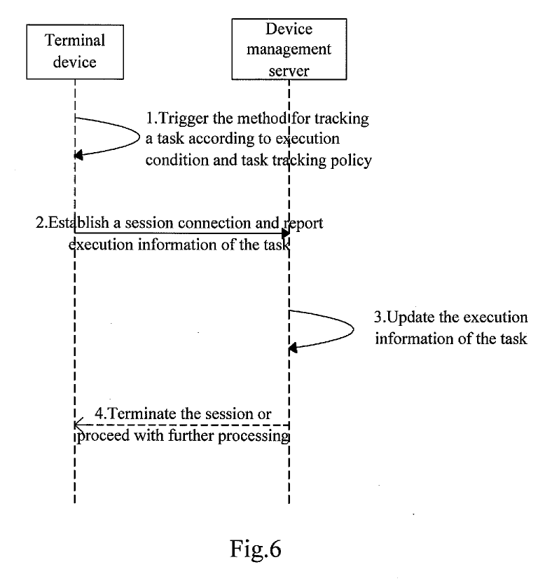

FIG. 6 illustrated a corresponding processing procedure which is as follows:

Step C1′, the terminal triggers the method for tracking a task according to the execution condition of a scheduling task and the task tracking policy, to track the scheduling task of the terminal.

Step C2′, the terminal establishes a device management session connection with the device management server, and reports execution information of the task through the session connection.

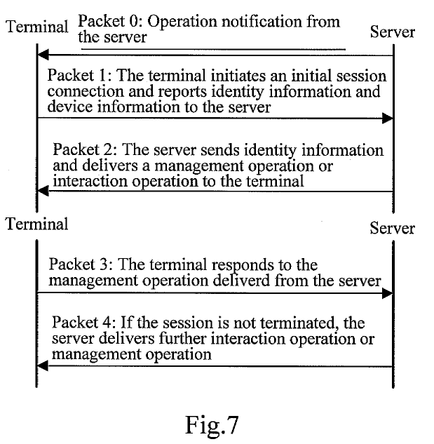

As illustrated in FIG. 7, the step C2′ may include the following steps:

First, the terminal determines execution information of the task to be reported to the server (i.e. the device management server). For example, the terminal determines the corresponding execution information of the task to be reported automatically, according to execution of the task and the task tracking policy.

Second, the terminal initiates an initial session connection, and reports to the server the identity authentication information, the terminal device information and the execution information of the scheduling task reported according to the tracking policy, so that the server may proceed with further processing.

Step C3′, the device management server receives the information reported from the terminal, and updates the execution information of the task stored therein.

The execution information of the task may be reported by using the method of establishing a device management session between the terminal and the server, i.e. by transmitting a Generic Alert message.

Step C4′, the device management server terminates the session or proceeds with further processing.

When the mobile phone reports the execution information of the task according to the task tracking policy delivered from the device management server, the device management server may proceed with further processing according to the reported execution information of the task. The further processing of the task by the device management server will be detailed hereinafter.

D. When the mobile phone misses the execution condition of the task, the device management server delivers a task instruction, and the mobile phone operates according to the instruction.

Once obtaining the execution information of a task, the device management server analyzes according to the information. In general, operations delivered from the device management server may be divided into two types, one is a notification type of operation and the other is a compulsive-execution type of operation. An operation of the notification type provides the user with some relevant prompt information as well as some relevant options of operation instructions which may vary from one task to another. An operation of the compulsive-execution type is typically used in the case that a final time limit for executing a task is exceeded, and is further divided into two types, i.e. task execution operation and task canceling operation.

A processing flow of tracking and notifying by the device management server will be described with reference to a schematic diagram.

1. A processing flow when the final limited time for executing a task is due or exceeded

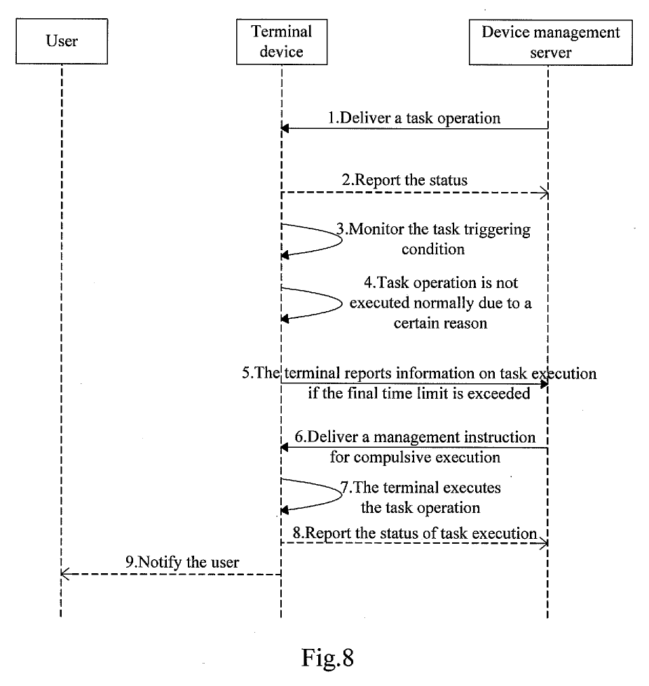

As illustrated in FIG. 8, the device management server mainly delivers two types of management instructions in this case, that is, a scheduling task instant-execution instruction (for a task which must be executed) and a scheduling task canceling instruction (for a task which is not necessary to be executed). Particularly, for a scheduling task which must be executed, the mobile phone displays information of compulsive execution to the user, to prompt the user for the compulsive execution of the scheduling task.

Step D1, the device management server delivers a compulsive execution instruction.

Step D2, the mobile phone executes the corresponding scheduling task.

Step D3, the mobile phone reports the execution status of the task to the device management server.

Step D4, the mobile phone notifies the user of the execution status of the task.

FIG. 8 illustrates the processing flow in which the device management server delivers a management instruction of compulsive execution in the case that a final time limit for executing a task is due or exceeded.

An example of an instruction, implemented through XML, from a server to compel a terminal to execute an operation will be given below.

<SyncML xmlns=‘SYNCML:SYNCML1.2’>

<SyncHdr>

<VerDTD>1.2</VerDTD>
<VerProto>DM/1.2</VerProto>
<SessionID>1</SessionID>
<MsgID>1</MsgID>
<Target>

<LocURI>IMEI:493005100592800</LocURI> //Destination address indicating mobile phone
terminal

</Target>
<Source>

<LocURI>http://www.syncml.org/mgmt-server</LocURI> //Server address

| </Source> | |
|---|---|
| <Cred> | //Certification information of both parties, omitted here |

...

</Cred>

</SyncHdr>
<SyncBody>

<!Prompt user about operation information>
<Alert>

<CmdID>2</CmdID>
<Data>1100</Data>
<Item></Item>
<Item>

<Data>Your antivirus software will be updated</Data>

</Item>

</Alert>
<!Below are instructions for complusive execution>
<excute>

<CmdID>4</CmdID>
<Item>

<Target>

<LocURI>./antivirus_data/update</LocURI>

</Target>

</Item>

</excute>
<Final/>

</SyncBody>

</SyncML>

2. A processing flow for a task not executed normally when the final limited time for executing the task is not exceeded

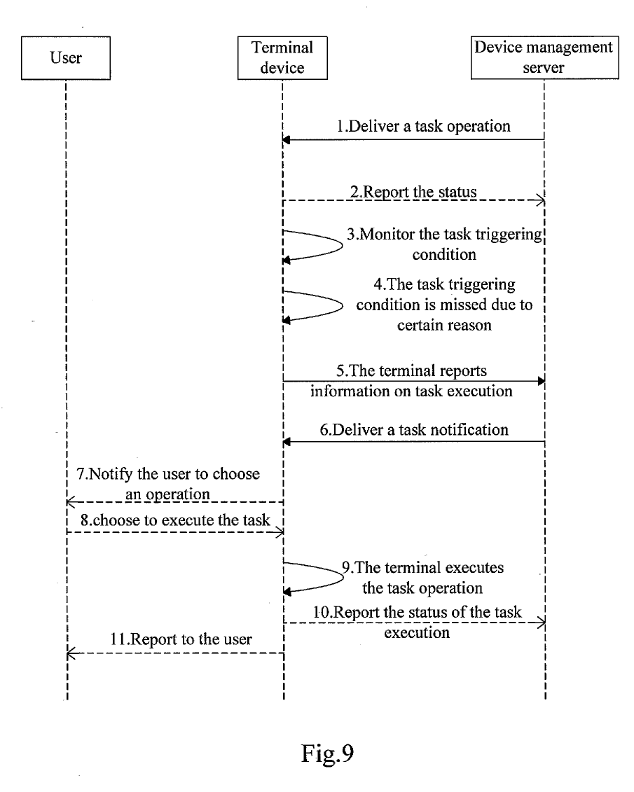

As illustrated in FIG. 9, the operations which the user is notified to choose include a task execution operation, a task postponing operation, a task rejecting operation (for a scheduling task which is not necessary to be executed), etc.

Step D1′, the device management server delivers an instruction allowing the user to select a task.

Step D2′, the mobile phone notifies the user to select a scheduling task to be executed.

Step D3′, the user selects a scheduling task to be executed.

Step D4′, the mobile phone executes the scheduling task selected by the user.

Step D5′, the mobile phone reports the execution status of the task to the device management server.

Step D6′, the mobile phone reports the execution status of the task to the user.

The above operations of delivering an instruction delivered from the device management server to the terminal are borne over the OMA DM protocol. The processing flow will be described in details hereinafter.

FIG. 9 illustrates a processing flow in which the device management server delivers an operation notification in the case that an execution condition of a task is missed and the mobile phone does not execute the task normally. In step 4 of FIG. 4, an event occurs which prevents a normal execution of a task, for example, the device management server delivers a scheduling task requiring to execute a task at the time 12:00 PM 20050803, but the mobile phone may be in a switched-off status due to various reasons and hence can not execute the scheduling task normally. In step D1′, the device management server may also deliver an instruction to cancel execution of the task, in addition to an instruction for compulsive execution. The options provided to the users in step D2′ may include a task execution operation, a task postponing operation, a task rejecting operation, etc. (depending upon the type and policy of the task).

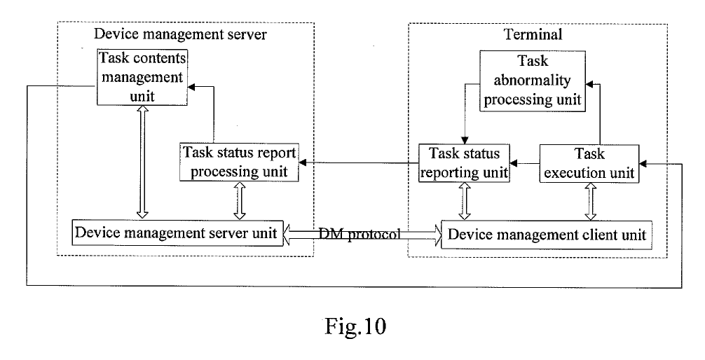

According to another embodiment, a system for processing a scheduling task is provided in device management, which may manage a scheduling task delivered from a device management server to a terminal. The specific structure of the system is illustrated in FIG. 10, which includes:

a device management server, adapted to deliver a scheduling task to a terminal and to receive tracking information of the scheduling task reported from the terminal;

a terminal, adapted to receive the scheduling task, to track the delivered scheduling task according to an execution condition and a tracking policy of the scheduling task, and to report the tracking information to the device management server.

The structures of the device management server and the terminal will be described respectively hereinafter.

A device management server

The device management server is adapted to deliver a management scheduling task to the terminal for device management on the terminal. The device management server includes a task content management unit and a task status report processing unit.

The task contents management unit is adapted to manage a scheduling task. The task contents management unit may deliver a corresponding task instruction to the terminal according to the contents of the scheduling task, that is, the task contents management unit may deliver a corresponding scheduling task for managing the terminal. According to an embodiment of the invention, a task instruction may be delivered to the terminal after the task status report processing unit receives the information that the terminal does not execute the scheduling task according to an execution condition, and the terminal in turn executes an operation according to this task instruction. This task instruction may be either a compulsive-execution instruction or an operation selection instruction. The information of a particular task instruction has been described above and thus will not be repeated.

The task status report processing unit is adapted to track and receive a result of execution of a management task and abnormal status information on execution of the scheduling task, reported from the terminal, that is, the information of the normal or normal status during the execution of the scheduling task.

A device management server unit is provided in the device management server as a communication interface unit between the device management server and the terminal. The server may interact with the terminal through, but not limited to, using the DM protocol as the bearer communication protocol. The particular implementation of the DM protocol may be found in the OMA DM specification.

Terminal

The terminal provides a device management client unit as a communication interface unit between the terminal and the device management server, which may use, but not limited to, the DM protocol as the bearer communication protocol. The specific description of the DM protocol may be found in the OMA DM specification. In order to receive a scheduling task delivered from the device management server through, for example, the DM protocol, the terminal according to an embodiment of the invention further includes the following modules:

A task execution unit, which is adapted to process a scheduling task for managing the terminal, which is delivered from the device management server over the DM protocol and then forwarded from the device management client unit, and to report a result of execution of the scheduling task (including the normal execution or the abnormal execution) through the task status reporting unit. In addition to a management task (i.e. a scheduling task) for normal execution, the task execution unit is also adapted to receive an instruction for compulsive execution of the task or an operation selection instruction delivered from the device management server, and to perform corresponding compulsive execution or display information prompting a user to select an operation, with respect to the corresponding scheduling task according to the instruction. The processing performed according to the task instruction has been described above, and will not be repeated here. The task execution unit is further adapted to send abnormal management task information to a task abnormality processing module.

A task abnormality processing unit, which is adapted to process an abnormal scheduling task and report task abnormality status information through the task status reporting unit according to a task tracking policy, that is, to report information on an abnormality which may occur during execution of a corresponding scheduling task, for example, failing to execute a corresponding scheduling task according to a predetermined condition, missing the time for executing a corresponding scheduling task, or having not executed the corresponding scheduling task yet, etc.

A task status reporting unit, which is adapted to report to the device management server the status information on execution of a task from the task execution unit or the task abnormality execution unit, particularly through a short message or a session connection. The particular processing procedures for reporting a task abnormality have been described above with reference to FIG. 5 to FIG. 7, and will not be repeated here.

The embodiments of the invention provide an effective mechanism for ensuring the execution of a scheduling task in the case that a certain abnormality results in the automatic switching off of a mobile phone, or user intervention causes the mobile phone to switch off, etc. so that the device management server may track the execution of the scheduling task normally. In this way, the uncertainty in device management on the mobile phone may be reduced, the flexibility of device management on the mobile phone may be increased, the scheduling demand from the user may be satisfied, and the quality of the device management services may be improved.

The embodiments of the invention have been described for the better understanding of the invention, and should not be considered a limitation to the scope of the invention. Therefore, the modifications recognized by a person of ordinary skill in the art without any inventive effort in light of the invention shall fall into the scope of the invention.

It should be emphasized that the above-described embodiments, particularly, any preferred embodiments, are merely possible examples of implementations, merely set forth for a clear understanding of the principles of the invention. Many variations and modifications may be made to the above-described preferred embodiments without departing substantially from the spirit and principles of the invention. All such modifications and variations are intended to be included herein within the scope of this disclosure and the above-described preferred embodiments and protected by the following claims.

What is claimed is:

1. A method for processing a scheduling task in device management, comprising:
receiving a scheduling task delivered by a device management server;
tracking the scheduling task according to an execution condition and a task tracking policy of the scheduling task; and
reporting a tracking information to the device management server according to the task tracking policy.

2. The method according to claim 1, further comprising:
delivering, by the device management server, a task instruction to a device if determining that the terminal does not execute the task according to an execution condition, wherein the determining is performed according to the reported tracking information; and
executing, by the device, the task according to the task instruction.

3. The method according to claim 2, wherein the task instruction is a compulsive-execution instruction according to which the device executes a scheduling task, or
the task instruction is an operation selection instruction according to which the device selects a corresponding scheduling task to be executed.

4. The method according to claim 3, further comprising: reporting, by the device, to the device management server execution status of executing the scheduling task according to the task instruction; and/or displaying, by the device, the execution status of executing the scheduling task according to the task instruction.

5. The method according to claim 3, wherein when the task instruction is an operation selection instruction, the method further comprises:
outputting, by the device, a notification to a user to select an operation to be executed;
receiving, by the device, inputted information on a scheduling task selected to be executed;
and executing the scheduling task according to the information on the scheduling task selected to be executed.

6. The method according to claim 3, wherein the compulsive-operation instruction is a scheduling task instant-execution instruction or a scheduling task canceling instruction and the operation selection instruction is a scheduling task execution instruction, a scheduling task postponing instruction or a scheduling task rejecting instruction.

7. The method according to claim 1, wherein the task tracking policy comprises at least one of:
notifying the device management server by the device when reaching or exceeding a time limit for executing a scheduling task;
notifying the device management server by the device if an execution condition of a scheduling task is modified by a user;
notifying the device management server by the device if an execution condition of a task is missed and the device does not execute normally; or
reporting information of a task to the device management server automatically upon a predetermined event or at a predetermined time.

8. The method according to claim 1, wherein reporting the tracking information to the device management server comprises:
sending, by the device, to a short message gateway by using a short message, the tracking information obtained according to the execution condition and the task tracking policy of the task, and sending, by the short message gateway, the tracking information to the device management server; or
reporting, by the device, to the device management server through a session connection which is established between the device and the device management server, the tracking information obtained according to the execution condition and the task tracking policy of the task.

9. A device for communication with a device management server, capable of receiving a scheduling task delivered from the device management server, further comprising:
a task execution unit, capable of executing a scheduling task delivered from the device management server, and providing a task execution result;
a task abnormality processing unit, capable of processing an abnormal task, and reporting a task abnormality status according to a predetermined task tracking policy; and
a task status reporting unit, capable of reporting to the device management server the task execution result and the task abnormality status.

10. The device according to claim 9, wherein the task execution unit is further capable of receiving an compulsive-execution instruction for a scheduling task or an operation selection instruction, and performing a compulsive execution or display the information prompting to select an operation with respect to the scheduling task according to the instruction.

11. The device according to claim 9, wherein the task status reporting unit reports to the device management server through a short message or a session connection.

12. A device management server for delivering a scheduling task to a device and managing the device, comprising:
a task status report processing unit, capable of receiving a task execution result and task abnormality status information reported from the device with respect to the scheduling task.

13. The device management server according to claim 12, further comprising:
a task contents management unit, capable of delivering a task instruction to the device if determining according to an execution condition that the device does not execute the scheduling task according to the reported task execution result and task abnormality status information;
wherein the device operates according to the task instruction, and the task instruction is a compulsive-execution instruction or an operation selection instruction.

14. A system for processing a scheduling task comprising:
a device management server, capable of delivering a scheduling task to a terminal, and obtaining a tracking information from the terminal; and
a device, capable of receiving the scheduling task, and tracking the scheduling task according to an execution condition and a task tracking policy of the scheduling task, and reporting the tracking information to the device management server.
